(19) United States
(12) Patent Application Publication
(10) Pub. No.: US 2012/0196070 A1
(43) Pub. Date: Aug. 2, 2012

(54) RELEASE AGENT, RELEASE MATERIAL, AND ADHESIVE TAPE

(75) Inventors: Tsuyoshi Hiramatsu, Ibaraki-shi (JP); Toru Iseki, Ibaraki-shi (JP)

(73) Assignee: NITTO DENKO CORPORATION, Ibaraki-shi, Osaka (JP)

(21) Appl. No.: 13/500,265

(22) PCT Filed: Sep. 27, 2010
(86) PCT No.: PCT/JP2010/066722

§ 371 Date: Apr. 4, 2012

(30) Foreign Application Priority Data
Oct. 5, 2009 (JP) 2009-231844
Dec. 21, 2009 (JP) 2009-289741

(51) Int. Cl. C09J 7/02; C09D 123/08

(52) U.S. Cl. 428/41.3; 524/570

(57) ABSTRACT

The present invention provides a polyolefin-based release agent containing liquid hydrocarbon with viscosity at 38° C. of 5-1500 Pa·s as measured according to JIS K7117-1.

### TECHNICAL FIELD

The present invention relates to a polyolefin-based release agent comprising polyolefin as a main component, and a release material and an adhesive tape, which contain the release agent.

### BACKGROUND ART

Release material is made of a substrate such as paper, plastic film and plastic laminated paper and the like and a release agent layer formed on at least one surface of the substrate, and is used for protecting the adhesive surface of an adhesive tape, an adhesive sheet, a label and the like, and for the production step of a ceramic green sheet and the like.

The release agent includes a silicone-based release agent, a long-chain alkyl release agent, a polyolefin-based release agent, a fluorinated release agent and the like. For a certain use such as application related to electronic component and the like, since a silicone-based release agent may cause a problem, a non-silicone-based release agent such as a polyolefin-based release agent and the like is used.

A release material obtained by dissolving a polyolefin-based release agent in an organic solvent, and applying the solution to a substrate is recited as an example in patent documents 1-3 and the like.

Patent documents 1 and 2 describe release materials obtained by dissolving polyolefin alone in an organic solvent and applying the solution to a substrate. In addition, patent document 3 describes a release agent containing polyolefin crosslinked by using modified polyolefin having a functional group and an isocyanate-based crosslinking agent, and a release agent obtained by combined use with an unmodified polyolefin free of a functional group, and teaches that release materials improved in solvent resistance, heat resistance and adhesion to substrate can be obtained using these release agents.

However, none of those patent documents specify the dependence of the peel force on the peel rate.

It is generally known that a release material with a small peel force can be obtained by using, as a release agent, polyolefin with low density and low crystallinity, and the above-mentioned patent documents 1-3 are considered to use such type of polyolefin. However, a release material using such type of polyolefin tends to show high dependence of the peel force on the peel rate, wherein a high peel rate causes an extremely large peel force, thus making use thereof difficult. Particularly, this tendency becomes striking when the release material is laminated on an adhesive and preserved under humidification.

### DOCUMENT LIST

### Patent Documents

patent document 1: JP-A-55-152775
patent document 2: JP-A-6-99551
patent document 3: JP-A-2004-91776

### SUMMARY OF THE INVENTION

### Problems to be Solved by the Invention

A problem to be solved by the invention is to provide a polyolefin-based release agent with reduced dependence of the peel force on the peel rate, wherein a high peel rate does not cause an extremely large peel force.

Another problem to be solved by the invention is to provide a polyolefin-based release agent with reduced dependence of the peel force on the peel rate even when it is laminated on an adhesive and preserved under humidification.

A still another problem to be solved by the invention is to provide a release material and an adhesive tape having a release agent layer comprising the release agent.

### Means of Solving the Problems

The present inventors have conducted intensive studies of the above-mentioned problems and found that a release material with reduced dependence of the peel force on the peel rate can be obtained by adding liquid hydrocarbon having viscosity at 38° C. of 5-1500 Pa·s as measured according to JIS K7117-1 to a polyolefin-based release agent. In addition, they have found that an increase of the dependence of the peel force on the peel rate can be prevented even when the release material is laminated on an adhesive and preserved under humidification. Based on these findings, the present inventors have completed the present invention.

Accordingly, the present invention provides the following.

[1] A polyolefin-based release agent comprising a liquid hydrocarbon having viscosity at 38° C. of 5-1500 Pa·s as measured according to JIS K7117-1.
[2] The release agent of the above-mentioned [1] comprising a nonreactive polyolefin which is solid at 38° C.
[3] The release agent of the above-mentioned [2], wherein the aforementioned nonreactive polyolefin is an ethylene-based α-olefin copolymer.
[4] The release agent of the above-mentioned [2] or [3], wherein the aforementioned nonreactive polyolefin comprises not less than 90 wt % of a nonreactive polyolefin having tensile elasticity at 23° C. of not more than 10 MPa and tensile fracture stress at 23° C. of not more than 8 MPa.
[5] The release agent of any one of the above-mentioned [2] to [4], wherein the content of the liquid hydrocarbon is 3-30 parts by weight relative to the total 100 parts by weight of the aforementioned liquid hydrocarbon and the aforementioned nonreactive polyolefin.
[6] The release agent of any one of the above-mentioned [1] to [5], wherein the aforementioned liquid hydrocarbon and the aforementioned nonreactive polyolefin are contained in a total amount of not less than 80 wt % of the release agent.
[7] The release agent of any one of the above-mentioned [1] to [6], further comprising an isocyanate-based crosslinking agent.
[8] The release agent of the above-mentioned [7], wherein the aforementioned isocyanate-based crosslinking agent is an aromatic isocyanate having not less than 3 isocyanate groups in one molecule.
[9] The release agent of the above-mentioned [8], wherein the aforementioned aromatic isocyanate having not less than 3 isocyanate groups in one molecule is an adduct of an aromatic diisocyanate with a polyvalent alcohol.
[10] The release agent of the above-mentioned [7], wherein the aforementioned isocyanate-based crosslinking agent is an alicyclic isocyanate having not less than 3 isocyanate groups in one molecule.
[11] The release agent of the above-mentioned [10], wherein the aforementioned alicyclic isocyanate having not less than 3 isocyanate groups in one molecule is an adduct of an alicyclic diisocyanate with a polyvalent alcohol.
[12] The release agent of any one of the above-mentioned [1] to [11], further comprising polyolefin polyol.
[13] The release agent of the above-mentioned [12], wherein the aforementioned polyolefin polyol has a number-average molecular weight of 1500-50000.
[14] The release agent of any one of the above-mentioned [1] to [13], wherein the content of the isocyanate-based crosslinking agent is 0.5-20 parts by weight relative to the total 100 parts by weight of the aforementioned liquid hydrocarbon and the aforementioned nonreactive polyolefin.
[15] A release material comprising a substrate and a release agent layer on at least one surface of the substrate, wherein the release agent layer comprises the release agent of any one of the above-mentioned [1] to [14].
[16] An adhesive tape comprising an adhesive layer and the release material of the above-mentioned [15] on at least one surface of the adhesive layer, wherein the aforementioned adhesive layer is in contact with a release agent layer of the aforementioned release material.
[17] An adhesive tape comprising a substrate, an adhesive layer on one surface of the substrate, and a release agent layer comprising the release agent of any one of the above-mentioned [1] to [14] on the other surface of the substrate.

### Effect of the Invention

The release material of the present invention obtained by dissolving a polyolefin-based release agent in an organic solvent, and applying the solution to a substrate shows superior peeling workability, since it has lower dependence of the peel force on the peel rate. Moreover, since the release material shows reduced dependence of the peel force on the peel rate even when it is laminated on an adhesive and preserved under humidification, it is superior in the peeling workability even after preservation under humidification.

### DESCRIPTION OF EMBODIMENTS

### 1. Release Agent

The present invention provides a polyolefin-based release agent comprising (1) a liquid hydrocarbon having viscosity at 38° C. of 5-1500 Pa·s as measured according to JIS K7117-1. The release agent may further contain (2) nonreactive polyolefin which is solid at 38° C., (3) an isocyanate-based crosslinking agent, and (4) polyolefin polyol.

### (1) Liquid Hydrocarbon

In the present invention, liquid hydrocarbon has viscosity at 38° C. as measured according to JIS K7117-1 (hereinafter to be referred to as viscosity at 38° C.) of 5-1500 Pa·s. Examples of the liquid hydrocarbon include olefin polymer and the like. From the aspects of compatibility, it is preferably a liquid hydrocarbon polymer obtained by polymerizing ethylene and/or unsaturated hydrocarbon having a carbon number of 3-5 (e.g., liquid ethylene olefin copolymer, liquid polybutadiene, liquid polyisoprene, liquid hydrogenated polybutadiene, liquid hydrogenated polyisoprene, liquid polyisobutene etc.). Examples of the unsaturated hydrocarbon having a carbon number of 3-5 include propylene, 1-butene, isobutene, 2-butene, butadiene, 1-pentene, 2-pentene, isopentene, isoprene and the like. The polymerization can be performed by a known method, and radical polymerization, cation polymerization and the like can be adopted.

In the present invention, the viscosity at 38° C. is generally 5-1500 Pa·s, preferably 5-1300 Pa·s. The release agent of the present invention can reduce dependence of the peel force of the release material on the rate without decreasing the adhesive force of an adhesive tape and the like, since it contains such liquid hydrocarbon. When the above-mentioned viscosity at 38° C. is less than 5 Pa·s, the dependence of detachability on the rate tends to reduce only insufficiently. When the amount of the liquid hydrocarbon to be used is increased to sufficiently reduce the dependence of the peel force on the rate, the adhesive force of an adhesive tape and the like decreases. When the above-mentioned viscosity at 38° C. is over 1500 Pa·s, since flowability at around 10-30° C., at which use of a release material is assumed, becomes low, the dependence of the peel force on the rate tends to reduce only insufficiently.

In the present invention, commercially available products may also be used as liquid hydrocarbon as long as the viscosity thereof at 38° C. is 5-1500 Pa·s. Examples of the commercially available product include LUCANT HC-600 (8.5 Pa·s), HC-2000 (34 Pa·s) (all manufactured by Mitsui Chemicals, Inc.), Kuraprene LIR-30 (74 Pa·s), LIR-50 (480 Pa·s), LIR-290 (1000 Pa·s), LBR-300 (280 Pa·s) (all manufactured by KURARAY CO., LTD.), Nisseki Polybutene HV-100, HV-300, HV-1900 (all manufactured by Nippon Oil Corporation), Nissan Polybutene 10N, 30N, 200N (all manufactured by NOF CORPORATION) and the like.

The content of the liquid hydrocarbon having viscosity at 38° C. of 5-1500 Pa·s is 3-30 parts by weight, preferably 4-20 parts by weight, particularly preferably 5-15 parts by weight, relative to the total 100 parts by weight of liquid hydrocarbon and nonreactive polyolefin (below-mentioned). When the content is less than 3 parts by weight, the dependence of detachability on the rate does not decrease sufficiently, and when it exceeds 30 parts by weight, the adhesive force of an adhesive tape and the like unpreferably decreases and the film strength of the release agent layer unpreferably becomes low.

### (2) Nonreactive Polyolefin

In the present invention, nonreactive polyolefin is a polyolefin that does not react with the below-mentioned isocyanate-based crosslinking agent and polyolefin polyol. For example, it is a polyolefin free of a functional group (hydroxyl group, amino group, carboxy group, isocyanate group (also referred to as “isocyanato group”) etc.) that reacts with an isocyanate-based crosslinking agent and polyolefin polyol. In the present invention, since even a small amount of functional group may cause heavy peeling depending on the kind of an adhesive and conditions of preservation in the state of being in contact with an adhesive, unmodified polyolefin completely free of the aforementioned functional group is preferable.

In the present invention, nonreactive polyolefin is solid at 38° C. Being “solid at 38° C.” in the present invention means, for example, that the melting point is not less than 38° C. (preferably not less than 45° C., particularly preferably not less than 50° C.). When the melting point is less than 38° C., the heat resistance becomes insufficient, and it tends to cause heavy peeling when preserved at not less than 50° C. and in the state of being in contact with an adhesive. The upper limit of, for example, ethylene-based α-olefin copolymer is preferably not more than 80° C., since a resin having a high melting point degrades solubility in organic solvents. The melting point is a maximum peak temperature on an endothermic curve measured by a differential scanning calorimeter (DSC), which is obtained from an endothermic curve when about 5 mg of a sample is packed in an aluminum pan, heated to 200° C. at 10° C./min, maintained at 200° C. for 5 min, cooled to room temperature at 10° C./min and heated at 10° C./min.

The nonreactive polyolefin in the present invention is not particularly limited as long as the aforementioned requirements are satisfied. However, for example, not less than 90 wt % (preferably not less than 95 wt %, particularly preferably 100 wt %) of nonreactive polyolefin contained in the release agent preferably has tensile elasticity at 23° C. of not more than 10 MPa (more preferably not more than 8 MPa, further preferably not more than 7 MPa, most preferably not more than 6 MPa), and tensile fracture stress at 23° C. of not more than 8 MPa (more preferably not more than 6 MPa, most preferably not more than 4 MPa). When the content of the nonreactive polyolefin having tensile elasticity at 23° C. of not more than 10 MPa, and tensile fracture stress at 23° C. of not more than 8 MPa is not less than 90 wt %, an influence of other nonreactive polyolefin is suppressed, and large peel force when peeled at a low speed and/or a high speed can be prevented. When the tensile elasticity at 23° C. is not more than 10 MPa, large peel force can be prevented both when peeled at a low speed and a high speed. Moreover, when the tensile fracture stress at 23° C. is not more than 8 MPa, large peel force can be prevented when peeled at a high speed.

While the lower limit of the tensile elasticity at 23° C. is not particularly limited, when it is too small, sufficient strength of the coated film cannot be obtained easily. Thus, it is not less than 2 MPa, more preferably not less than 3 MPa. While the lower limit of the tensile fracture stress at 23° C. is not particularly limited, when it is too small, sufficient strength of the coated film cannot be obtained easily. Thus, it is not less than 1 MPa, more preferably not less than 2 MPa.

### [Measurement Methods of Tensile Elasticity and Tensile Fracture Stress]

The tensile elasticity at 23° C. and tensile fracture stress at 23° C. in the present invention are values measured by the following method.

Nonreactive polyolefin is dissolved in toluene to give 5-10 wt % solution, which is applied to a release film of a PET (poly(ethylene terephthalate)) substrate by using a Baker applicator or doctor blade type applicator. Immediately after drying by heating by a hot air dryer (100° C., 3 min), the substrate is cooled in 23° C. atmosphere to produce a nonreactive polyolefin film having a dried thickness of 20 μm. When solubility in toluene is poor, dissolution may accompany heating as necessary. The obtained nonreactive polyolefin film is cut out in the form of a rectangular strip of length 30 mm×width 100 mm. The nonreactive polyolefin film is tightly wound in longitudinal direction around one short side of the strip, while peeling the film off the release film to give a 30 mm-length rod-like sample.

This rod-like sample is subjected to a tensile test in 23° C. atmosphere under the conditions of chuck distance 10 mm and tensile speed 50 mm/min using a tensile tester (manufactured by Shimadzu Corporation, autograph AG-IS type) and a stress-strain curve at that time is obtained. The tensile elasticity is calculated from the inclination of the curve in the stress-strain curve immediately after the start of pulling. In addition, the stress upon breakage of the rod-like sample is determined as tensile fracture stress.

While the nonreactive polyolefin in the present invention is not particularly limited as long as it meets the aforementioned requirements, for example, a nonreactive polyolefin capable of dissolving in an organic solvent together with other materials to permit application to a substrate is preferable, and a low density nonreactive polyolefin showing good solubility in organic solvents is preferably used. A release agent using a low density polyolefin generally affords light peeling, but often shows high dependence of the peel force on the peel rate. In the present invention, a nonreactive polyolefin having tensile elasticity at 23° C. of not more than 10 MPa and tensile fracture stress at 23° C. of not more than 8 MPa is mainly used. Therefore, even when destruction should occur near the interface between the adhesive layer and the release agent layer during peeling, the neighborhood of the interface can be destroyed with a small force since the tensile fracture stress is small, and even when the peel rate becomes fast, the peel force does not become too high, and the dependence of the peel force on the peel rate can be made small.

Specifically, nonreactive polyolefin having a density of not more than 0.885 g/cm³ is preferable, and nonreactive polyolefin having a density of not more than 0.880 g/cm³ is more preferable. When the density exceeds 0.885 g/cm³, the solubility in organic solvents decreases so that application to the substrate tends to be difficult, and so that the detachability tends to decrease. The lower limit is preferably 0.855 g/cm³ or more, since low density is associated with low melting point, as well as poor heat resistance, for example, in ethylene-based α-olefin copolymers.

Examples of such polyolefin having low density include α-olefin copolymer containing, as a monomer unit, at least two kinds selected from the group consisting of ethylene, propylene and α-olefin having a carbon number of 4-20. Of these, a copolymer containing ethylene as a principal monomer unit (that is, ethylene-based α-olefin copolymer) is preferable. Here, examples of the α-olefin having a carbon number of 4-20 include 1-butene, 1-pentene, 3-methyl-1-butene, 1-hexene, 4-methyl-1-pentene, 3-methyl-1-pentene, 1-heptene, 1-octene, 1-decene, 1-dodecene and the like. In addition, the α-olefin copolymer may be any of a random copolymer, a block copolymer and a graft copolymer, with preference given to a random copolymer since it shows good detachability.

Ethylene-based α-olefin copolymer preferably comprises 50 to 95 mol %, more preferably 70 to 95 mol %, of an ethylene unit in the total units. One or more kinds selected from 1-butene, propylene, 1-hexene, and 1-octene are preferably used as a monomer unit other than ethylene. Particularly preferable copolymer includes ethylene-1-butene copolymer, ethylene-propylene copolymer and the like. Such ethylene-1-butene copolymer may contain a monomer unit derived from an α-olefin other than ethylene and 1-butene in an amount of not more than 10 mol %; and ethylene-propylene copolymer may contain a monomer unit derived from an α-olefin other than ethylene and propylene in an amount of not more than 10 mol %. Such a copolymer can be obtained by, for example, copolymerizing ethylene and an α-olefin using a catalyst consisting of a transition metal catalytic component (e.g., vanadium compounds, zirconium compounds) and an organic aluminum compound catalytic component so that the ethylene unit content in the copolymer will be as described above.

In the present invention, commercially available products may also be used as the α-olefin copolymer. As the ethylene-based α-olefin copolymer, TAFMER P series, TAFMER A series (all manufactured by Mitsui Chemicals, Inc.), ENGAGE (manufactured by Dow Chemical Company) and the like are preferably used. Particularly, as the ethylene-based α-olefin copolymer which is solid at 38° C., TAFMER P-0080K (melting point 51° C.), TAFMER P-0280 (melting point 51° C.), TAFMER A-35070S (melting point 50° C.), TAFMER P-0680 (melting point 51° C.), TAFMER P-0180 (melting point 51° C.), TAFMER P-0480 (melting point 51° C.), TAFMER P-0275 (melting point 38° C.), TAFMER P-0775 (melting point 38° C.) (all manufactured by Mitsui Chemicals, Inc.) and the like are preferably used.

In the present invention, one or more kinds of nonreactive polyolefins can be used for controlling the peel force. When two or more kinds are used, polyolefins satisfying the aforementioned requirements of the tensile elasticity and tensile fracture stress may be used, or polyolefin satisfying the aforementioned requirements of the tensile elasticity and tensile fracture stress, and polyolefin not satisfying the requirements may be used in combination. The polyolefin not satisfying the aforementioned requirements and having tensile elasticity of over 10 MPa preferably has tensile elasticity of not more than 100 MPa, and a polyolefin having tensile fracture stress of over 8 MPa preferably has tensile fracture stress of not more than 35 MPa.

In the present invention, when only one kind of nonreactive polyolefin is used, the nonreactive polyolefin preferably meets the aforementioned requirements of the tensile elasticity and tensile fracture stress, and has MFR (melt flow rate) at 230° C. of not more than 100 g/10 min, more preferably not more than 70 g/10 min, further preferably not more than 50 g/10 min, particularly preferably not more than 10 g/10 min, in view of the strength of the coated film for forming a release agent layer.

In addition, when two or more kinds of nonreactive polyolefins are used, at least one kind of the nonreactive polyolefin meeting the requirements of the aforementioned tensile elasticity and tensile fracture stress preferably has MFR at 230° C. of not more than 100 g/10 min. In addition, the proportion of the nonreactive polyolefin having MFR of not more than 100 g/10 min is preferably not less than 10 wt %, more preferably not less than 50 wt %, of the entire nonreactive polyolefin. As long as this condition is satisfied, a polyolefin having MFR at 230° C. of more than 100 g/10 min can be used as other polyolefin meeting the requirements of the aforementioned tensile elasticity and tensile fracture stress, or as a polyolefin not meeting the requirements.

In the present invention, the content of the nonreactive polyolefin in a release agent is preferably not less than 70 wt %, more preferably not less than 75 wt %, more preferably not less than 80 wt %. When the content of the nonreactive polyolefin in a release agent is less than 70 wt %, the increased contents of polyolefin polyol and isocyanate-based crosslinking agent tend to degrade detachability and increase peel force. When the content of the liquid hydrocarbon is increased, the strength of the coated film tends to decrease. The upper limit of the content of nonreactive polyolefin is not particularly limited. When the content of liquid hydrocarbon is set to a minimum amount of 3 parts by weight, the content of the nonreactive polyolefin in a release agent is preferably not more than 96 wt %, more preferably not more than 95 wt %, to obtain sufficient strength of the coated film.

In the present invention, moreover, the total content of the above-mentioned liquid hydrocarbon and nonreactive polyolefin which is solid at 38° C. is preferably not less than 80 wt %, more preferably not less than 85 wt %, particularly preferably not less than 90 wt %, of the release agent. When the total content of the above-mentioned liquid hydrocarbon and nonreactive polyolefin which is solid at 38° C. is less than 80 wt %, the detachability tends to degrade and the peel force becomes high. The upper limit of the total content of liquid hydrocarbon and nonreactive polyolefin which is solid at 38° C. is not particularly limited. To obtain sufficient strength of the coated film, the aforementioned total is preferably not more than 99 wt %, more preferably not more than 98 wt %, of the release agent.

### (3) Isocyanate-Based Crosslinking Agent

The isocyanate-based crosslinking agent contained in the release agent of the present invention may be any of aromatic and aliphatic. However, since adhesion to a substrate is obtained, aromatic isocyanate and alicyclic isocyanate are preferable. Among aromatic isocyanate and alicyclic isocyanate, one having not less than 3 isocyanate groups in one molecule is particularly preferable in view of the strength, heat resistance and the like of a release agent layer. As one having not less than 3 isocyanate groups in one molecule, an adduct of an aromatic diisocyanate or an alicyclic diisocyanate with a polyvalent alcohol is most preferable. Examples of the adduct with polyvalent alcohol include terminal-isocyanate-containing compound obtained reacting an excess amount of aromatic diisocyanate such as tolylene diisocyanate, diphenylmethane diisocyanate, 1,5-naphthylene diisocyanate, tolidine diisocyanate, xylylene diisocyanate, tetramethylxylylene diisocyanate and the like, or an excess amount of alicyclic diisocyanate such as isophorone diisocyanate, hydrogenated xylylene diisocyanate, hydrogenated diphenylmethane diisocyanate, dimer acid diisocyanate, norbornane diisocyanate, trans-cyclohexane diisocyanate, hydrogenated tolylene diisocyanate and the like with polyvalent alcohol. Of these, an adduct of tolylene diisocyanate, xylylene diisocyanate, hydrogenated xylylene diisocyanate or isophorone diisocyanate with a polyvalent to alcohol is preferable, and an adduct of tolylene diisocyanate with a polyvalent alcohol is more preferable particularly from the aspect of reactivity and adhesion to a substrate. Examples of the polyvalent alcohol include aliphatic polyvalent alcohol such as ethylene glycol, glycerin, trimethylol propane, pentaerythritol, ditrimethylol propane, dipentaerythritol and the like, and the like, with preference given to trimethylol propane. In addition, a multimer (e.g., isocyanurate form) of aromatic diisocyanate or alicyclic diisocyanate can be preferably used.

Aromatic isocyanate and alicyclic isocyanate have low compatibility with nonreactive polyolefin, and when used as a crosslinking component of a release agent, it is compatible with nonreactive polyolefin only to a level that does not impair detachability. Therefore, the remaining aromatic isocyanate and alicyclic isocyanate incompatible with nonreactive polyolefin locally exist between a layer containing liquid hydrocarbon and nonreactive polyolefin as main components and a substrate, and greatly contribute to the adhesion between a release agent layer and a substrate.

The content of the isocyanate-based crosslinking agent is 0.5-20 parts by weight, preferably 1.0-15 parts by weight, more preferably 1.5-10 parts by weight, relative to 100 parts by weight of the nonreactive polyolefin. When the content is within these ranges, an adverse influence of short pot life and the like is not observed, and more superior adhesion to a substrate can be achieved.

### (4) Polyolefin Polyol

While the polyolefin polyol in the present invention is to be reacted with an isocyanate-based crosslinking agent, it is preferable that the polyol be well compatible with the nonreactive polyolefin.

For example, the number-average molecular weight (Mn) of the polyolefin polyol is 1500-50000, preferably 1500-5000, more preferably 1500-4000, most preferably 1500-3000.

When the number-average molecular weight (Mn) is within the above range, polyolefin polyol can be moderately dissolved in both a layer mainly containing a liquid hydrocarbon and a nonreactive polyolefin and a layer mainly containing an isocyanate-based crosslinking agent (i.e., a layer containing smaller amount of nonreactive polyolefin) in the release agent layer. Since polyolefin polyol having the aforementioned molecular weight can be moderately dissolved in the layer mainly containing a liquid hydrocarbon and a nonreactive polyolefin, the strength and heat resistance of the release agent layer can be improved, and a release agent layer having superior appearance, which is free of white cloud, can be obtained. In addition, since excess hydroxyl group due to polyolefin polyol does not occur in a layer mainly containing a liquid hydrocarbon and nonreactive polyolefin, a lightly peelable release agent layer can be obtained. Furthermore, in the layer mainly containing an isocyanate-based crosslinking agent (i.e., a layer containing smaller amount of nonreactive polyolefin) in the release agent layer, an isocyanate-based crosslinking agent and polyolefin polyol can be reacted moderately, and more superior adhesion to a substrate can be obtained.

The kind of polyolefin polyol is not particularly limited. Examples thereof include polyethylene-based polyol, polypropylene-based polyol, polybutadiene polyol, hydrogenated polybutadiene polyol, polyisoprene polyol, hydrogenated polyisoprene polyol and the like. Of these, hydrogenated polyisoprene polyol and polyisoprene polyol are preferable, in view of the compatibility with polyolefin and influence on the peel force.

In addition, polyolefin polyol preferably has a hydroxyl value (mg KOH/g) of not less than 20, in view of the strength and hardenability of the coated film containing a release agent. Moreover, in view of the influence on the peel force, the hydroxyl value (mg KOH/g) is preferably not more than 75, more preferably 25-60.

In the present invention, the polyolefin polyol can be a commercially available product and, it includes for example, Poly bdR-45HT (hydroxyl-terminated liquid polybutadiene: Mn=2800, hydroxyl value=46.6 mg KOH/g, manufactured by Idemitsu Kosan Co., Ltd.), Poly ip (hydroxyl-terminated liquid polyisoprene: Mn=2500, hydroxyl value=46.6 mg KOH/g, manufactured by Idemitsu Kosan Co., Ltd.), Epole (hydroxyl-terminated liquid hydrogenated polyisoprene: Mn=2500, hydroxyl value=50.5 mg KOH/g, manufactured by Idemitsu Kosan Co., Ltd.), GI-1000 (hydroxyl group-containing liquid hydrogenated polybutadiene: Mn=1500, hydroxyl value=60-75 mg KOH/g, manufactured by Nippon Soda Co., Ltd.), GI-2000 (hydroxyl group-containing liquid hydrogenated polybutadiene: Mn=2100, hydroxyl value=40-55 mg KOH/g, manufactured by Nippon Soda Co., Ltd.), GI-3000 (hydroxyl group-containing liquid hydrogenated polybutadiene: Mn=3000, hydroxyl value=25-35 mg KOH/g, manufactured by Nippon Soda Co., Ltd.) and the like. All of these polyols are liquid at ordinary temperature. In addition, UNISTOLE P-801 (16% toluene solution of hydroxyl group-containing polyolefin, toluene-free product thereof is a solid, hydroxyl value 40 mg KOH/g, manufactured by Mitsui Chemicals, Inc.) can also be used.

In the present invention, the content of polyolefin polyol in the release agent is set such that the value of A in the following formula (I) is 30-250, preferably 40-200, more preferably 50-150. When the value A is smaller than 30, the strength of the release agent layer tends to be insufficient, and when it is higher than 250, heavy peeling of the layer tends to occur.

[Formula 1]

A=hydroxyl value (mg KOH/g) of polyolefin polyol x parts by weight of polyolefin polyol relative to 100 parts by weight of polyolefin (I)

### (5) Urethane Catalyst

In the present invention, a urethane catalyst may be used for the reaction of an isocyanate-based crosslinking agent and a polyolefin polyol; useful urethane catalysts include catalysts for ordinary urethanization reactions. Urethane catalysts are exemplified by tin compounds such as dibutyltin dilaurate and dioctyltin dilaurate; carboxylates of metals such as zinc, cobalt, copper, and bismuth; amine compounds such as 1,4-diazabicyclo[2.2.2]octane; and chelate compounds of metals such as titanium and zirconium. Salts of bismuth with organic acid (salts of bismuth with alicyclic organic acids such as salts of bismuth with resin acids containing abietic acid, neoabietic acid, d-pimaric acid, iso-d-pimaric acid, or podocarpic acid, or a combination of two kinds or more thereof, as a main component; salts of bismuth with aromatic organic acids such as benzoic acid, cinnamic acid, and p-oxycinnamic acid; and the like) can also be used. In particular, from the viewpoint of compatibility with the release agent composition and urethanization reaction reactivity, dibutyltin dilaurate, dioctyltin dilaurate, salts of bismuth with carboxylic acids and salts of bismuth with resin acids are preferable.

The content of the urethane catalyst is preferably 0.05 to 2.0 parts by weight, more preferably 0.1 to 1.5 parts by weight, still more preferably 0.1 to 1.0 parts by weight, relative to 100 parts by weight of nonreactive polyolefin. When the content is less than 0.05 parts by weight, the catalytic effect is often insufficient; when the content exceeds 2.0 parts by weight, the catalyst is more likely to cause heavy peeling and troubles such as shortening of the pot life of the release agent in solution.

As mentioned here, the content of catalyst is expressed as parts by weight of active ingredient; for example, in the case of the solution type, prepared by dissolving an active ingredient compound like “PUCAT B7”, which is used in Examples below, in a solvent, the content means parts by weight of the active ingredient compound alone.

### (6) Other Optional Component

Where necessary, the release agent of the present invention may appropriately contain olefin-based resin other than the aforementioned nonreactive polyolefin, antioxidant, UV absorber, light stabilizer such as hindered amine light stabilizer and the like, antistatic agent, fillers such as carbon black, calcium oxide, magnesium oxide, silica, zinc oxide, titanium oxide etc., pigments, and the like.

### 2. Release Material

The present invention also provides a release material having a release agent layer comprised of the aforementioned release agent on at least one surface of a substrate.

### [Substrate]

Although the substrate in the present invention is not particularly limited, a plastic film is preferable because it has a smooth surface. Examples include polyester films such as poly(ethylene terephthalate) film and polybutylene terephthalate film and polyolefin films such as polyethylene film and polypropylene film. Paper such as craft paper, glassine paper, or fine paper may be used as the substrate. When paper is used, preference is given to one laminated with a plastic such as polyethylene or sealed up in order to prevent the release agent from impregnating the substrate in excess.

The substrate may be subjected to a corona treatment, plasma treatment, flame treatment and the like in advance as necessary. The thickness of the substrate is not particularly limited, and can be appropriately determined depending on the object of use. When a plastic film, it is generally about 12-250 μm, preferably 16-200 μm, more preferably 25-125 μm.

In addition, the substrate may appropriately contain, where necessary, antioxidant, UV absorber, light stabilizer such as hindered amine light stabilizer and the like, antistatic agent, fillers such as carbon black, calcium oxide, magnesium oxide, silica, zinc oxide, titanium oxide etc., pigments, and the like.

### [Release Agent Layer]

The release agent layer in the present invention is obtained by, for example, dissolving a composition that constitutes a release agent in a diluting solvent, applying the solution to a substrate, and then drying the solution. Although the solution concentration is not particularly limited, it is adjusted normally in the range of 0.1 to 5% by weight.

A diluting solvent is not particularly limited as long as it can uniformly dissolve each component. Since the release agent of the present invention contains nonreactive polyolefin as a main component, a hydrocarbon solvent is preferably used mainly to achieve uniform dissolution. Examples of the hydrocarbon solvents include aliphatic hydrocarbons such as normal hexane, normal heptane and the like, alicyclic hydrocarbons such as cyclohexane and the like, aromatic hydrocarbons such as toluene, xylene and the like. Where necessary, ketones such as methylethyl ketone, cyclohexanone, acetylacetone and the like, esters such as ethyl acetate and the like, alcohols such as methanol, ethanol, isopropyl alcohol and the like, and the like may be used in combination.

As a method for application of a release agent to a substrate, a conventionally-known method such as kiss-roll coater, bead coater, rod coater, Mayer bar coater, die coater, gravure coater and the like can be used. While the drying method is not particularly limited, a most general drying method is hot air drying, and a release agent layer can be formed by heating at about 80-150° C. depending on the heat resistance of the substrate.

The thickness of the release agent layer after drying is generally 30-500 nm, preferably 45-400 nm, particularly preferably 60-300 nm. When the thickness of the release agent layer is less than 30 nm, heavy peeling may occur, and when it exceeds 500 nm, blocking may occur when the release material is wound in the form of a roll, or peel force may become high.

In the release material, other layer may be formed between the release agent layer and the substrate. However, the release agent layer needs to be present on the outermost surface. The release agent layer is preferably directly formed on the substrate.

3. Adhesive Tape with Release Material

The present invention provides an adhesive tape having the above-described release material on at least one surface of an adhesive layer, wherein the adhesive layer is in contact with the release agent layer of the release material.

While an adhesive to be used for an adhesive layer of the adhesive tape is not particularly limited, rubber-based adhesives, acrylic adhesives, polyester-based adhesives and the like can be used. Of these, acrylic adhesives and polyester-based adhesives are preferable since they afford stable detachability.

An acrylic adhesive can be prepared by using an acrylic polymer obtained by a commonly used method of polymerization such as solution polymerization, emulsion polymerization, or UV polymerization as the principal agent, with various additives such as crosslinking agents, tackifiers, softening agents, antiaging agents, and fillers added thereto as required.

As the aforementioned acrylic polymer, a copolymer of a monomer mixture containing alkyl(meth)acrylate such as butyl(meth)acrylate, 2-ethylhexyl(meth)acrylate and the like as a main component, and, where necessary, other monomer as a copolymerizable modifying monomer (e.g., hydroxyl group-containing monomer such as 2-hydroxyethyl(meth)acrylate and the like, carboxyl group-containing monomer such as (meth)acrylic acid and the like, styrene-based monomer such as styrene and the like, vinyl esters such as vinyl acetate etc., and the like) can be used.

Examples of the polyester-based adhesive include an adhesive containing, as a base resin, a polyester-based polymer containing aliphatic carbonate diol (e.g., carbonate diol obtained by the reaction of a diol component such as butanediol and the like with a carbonate compound such as ethylenecarbonate and the like, and the like) as an inherent polyol component.

An adhesive tape can be obtained by, for example, applying an adhesive solution on a substrate and drying same. The thickness of the adhesive layer can be appropriately determined in consideration of the adhesiveness and the like, and is generally 3-100 μm, preferably 5-90 μm, more preferably 10-80 μm.

4. Adhesive Tape with Release Agent Layer Comprising Release Agent

In addition, the present invention provides an adhesive tape having an adhesive layer on one surface of a substrate, and a release agent layer comprising the release agent of the present invention on the other surface (hereinafter to be referred to as “back coating layer”).

The adhesive tape of the present invention may assume any of a roll-like wound form and a stacked sheet form. In both forms, the adhesive layer can be protected by a back coating layer.

In the adhesive tape, the adhesive layer and the back coating layer may be directly formed on a substrate, and other layer may be formed between these layers and the substrate. However, both the adhesive layer and the back coating layer need to be present on the outermost surface. In this way, when the adhesive tape is wound like a roll, or the adhesive tape in a sheet form is laminated, the adhesive layer can be protected by the back coating layer in contact with the adhesive layer. Both the adhesive layer and the back coating layer are preferably directly formed on a substrate.

While the adhesive to be used for the adhesive tape of the present invention is not particularly limited, rubber-based adhesives, acrylic adhesives, polyester-based adhesives and the like can be used. Of these, acrylic adhesives and polyester-based adhesives are preferable, since stable detachability can be obtained.

A back coating layer can be formed on a substrate on a surface opposite to the aforementioned adhesive layer by a method similar to that used for the aforementioned release agent layer, and the thickness of the back coating layer is preferably 30-500 nm, more preferably 45-400 nm, most preferably 60-300 nm, from the aspect of peel force.

### 5. Physical Properties, Characteristics and the Like

In the present specification, the physical property, characteristics and the like are measured by the following methods.

(1) density

A value measured according to ASTM D1505

(2) melt flow rate (230° C.)

A value measured according to ASTM D1238

(3) number-average molecular weight

A value measured according to ASTM D2503

(4) hydroxyl value

A value measured according to JIS K1557

### EXAMPLES

The present invention is hereinafter described more specifically by means of the following Examples and Comparative Examples, which, however, do not limit the scope of the invention. In the description below, “parts” and “%” indicate “parts by weight” and “% by weight”, respectively.

### <Preparation of Samples>

Respective components shown in the following Tables 1-5 were each dissolved in toluene according to the weight ratios shown in the following Table 6 to prepare a release agent solution having a concentration of 1.5%. The release agent solution was applied to a 38 μm-thick polyester film with Mayer bar #6, and heated by a hot air dryer at 130° C. for 1 min. The thickness of the release agent layer of the obtained release material was about 150 nm.

<Preparation of Adhesive Tape with Release Material>

An adhesive layer surface of a 50 mm-width acrylic adhesive tape No. 31B (manufactured by NITTO DENKO CORPORATION) was laminated on a release agent layer surface of release materials of Examples 1-13 and Comparative Examples 1-10 with a hand roller to give adhesive tapes with release material. The thus-prepared adhesive tape was used to measure low-speed peel force, high-speed peel force, high-speed peel force after preservation under humidification and residual adhesive force.

TABLE 1

| | | | | |
|---|---|---|---|---|
| | | | viscosity | viscosity |
| component | trade name | compound | (38° C.) (Pa · s) | (23° C.) (Pa · s) |

(1) liquid hydrocarbon

| | | | | | |
|---|---|---|---|---|---|
| a | LUCANT | ethylene-α-olefin | 8.5 | 21 | manufactured by Mitsui |
| | HC-600 | cooligomer | | | Chemicals, Inc. |
| b | LUCANT | ethylene-α-olefin | 34 | 94 | manufactured by Mitsui |
| | HC-2000 | cooligomer | | | Chemicals, Inc. |
| c | Kuraprene | hydrogenated polyisoprene | 1000 | | manufactured by KURARAY |
| | LIR-290 | (partially unhydrogenated) | | | CO., LTD. |
| d | Kuraprene | polybutadiene | 280 | | manufactured by KURARAY |
| | LBR-300 | | | | CO., LTD. |

(1′) other hydrocarbon

| | | | | | |
|---|---|---|---|---|---|
| e | LUCANT | ethylene-α-olefin | 0.36 | 0.88 | manufactured by Mitsui |
| | HC-40 | cooligomer | | | Chemicals, Inc. |
| f | paraffin | paraffin | (solid) | (solid) | manufactured by Wako Pure |
| | (m.p. 44-46° C.) | | | | Chemical Industries, Ltd. |
| g | paraffin | paraffin | (solid) | (solid) | manufactured by Wako Pure |
| | (m.p. 66-68° C.) | | | | Chemical Industries, Ltd. |
| h | Hi-Wax | polyethylene | (solid) | (solid) | manufactured by Mitsui |
| | NL100 | wax | | | Chemicals, Inc. |
| i | Diana Process Oil | petroleum-based | 0.08 | 0.2 | manufactured by Idemitsu |
| | PW-90 | hydrocarbon | | | Kosan Co., Ltd. |
| j | Diana Process Oil | petroleum-based | 0.35 | 0.94 | manufactured by Idemitsu |
| | PW-380 | hydrocarbon | | | Kosan Co., Ltd. |

TABLE 2
(2) nonreactive polyolefin

| | | | | | tensile | tensile | | |
|---|---|---|---|---|---|---|---|---|
| compo- | trade | polymer | melting | MFR | elasticity | fracture | density | |
| nent | name | type | point (° C.) | (g/10 min) | (MPa) | stress (MPa) | (g/cm³) | |
| k | TAFMER | ethylene- | 51 | 5.4 | 5.1 | 3.3 | 0.870 | manufactured by Mitsui |
| | P-0280 | propylene | | | | | | Chemicals, Inc. |
| l | TAFMER | ethylene- | 50 | 65 | 3.5 | 2.1 | 0.870 | manufactured by Mitsui |
| | A-35070S | 1-butene | | | | | | Chemicals, Inc. |
| m | TAFMER | ethylene- | 51 | 40 | 3.9 | 1.4 | 0.870 | manufactured by Mitsui |
| | P-0080K | propylene | | | | | | Chemicals, Inc. |

TABLE 3
(3) isocyanate-based crosslinking agent

| compo- | trade | | number of isocyanate | |
|---|---|---|---|---|
| nent | name | compound | group in one molecule | |
| n | CORONATE | 75% ethyl acetate solution of adduct of tolylene | 3 | manufactured by Nippon |
| | L | diisocyanate with trimethylol propane | | Polyurethane Industry Co., |
| o | CORONATE | 75% ethyl acetate solution of adduct of | 3 | manufactured by Nippon |
| | HL | hexamethylene diisocyanate with trimethylol propane | | Polyurethane Industry Co., |
| p | TAKENATE | 75% ethyl acetate solution of adduct of xylylene | 3 | manufactured by Mitsui |
| | D110N | diisocyanate with trimethylol propane | | Chemicals, Inc. |
| q | TAKENATE | 75% ethyl acetate solution of adduct of | 3 | manufactured by Mitsui |
| | D120N | hydrogenated xylylene diisocyanate with trimethylol | | Chemicals, Inc. |
| r | TAKENATE | 75% ethyl acetate solution of adduct of isophorone | 3 | manufactured by Mitsui |
| | D140N | diisocyanate with trimethylol propane | | Chemicals, Inc. |

TABLE 4
(4) polyolefin polyol

| | | | number-average molecular | hydroxyl value | |
|---|---|---|---|---|---|
| component | trade name | compound | weight (Mn) | (mgKOH/g) | |
| s | Epole | hydroxyl-terminated liquid | 2500 | 50.5 | manufactured by |
| | | hydrogenated polyisoprene | | | Idemitsu Kosan Co., |
| | | | | | Ltd. |
| t | Poly ip | hydroxyl-terminated liquid | 2500 | 46.6 | manufactured by |
| | | polyisoprene | | | Idemitsu Kosan Co., |
| | | | | | Ltd. |
| u | UNISTOLEP-801 | 16% toluene solution of | 5000< | 40 | manufactured by |
| | | hydroxyl group-containing | (solid content) | | Mitsui Chemicals, |
| | | polyolefin | | | Inc. |

TABLE 5
(5) urethane catalyst

| component | trade name | compound | |
|---|---|---|---|
| v | dibutyltin(IV) | dibutyltin | manufactured by |
| | dilaurate | dilaurate | Wako Pure Chemical |
| | | | Industries, Ltd. |
| w | PUCAT B7 | 58% mineral | manufactured by |
| | | spirit solution of | NIHON KAGAKU |
| | | bismuth resinate | SANGYO CO., LTD. |

TABLE 6

| | | liquid hydrocarbon and | | | | | | | | | | nonreactive | | | isocyanate-based | | | | | polyolefin | | | urethane | |
|---|---|---|---|---|---|---|---|---|---|---|---|---|---|---|---|---|---|---|---|---|---|---|---|---|
| | | other hydrocarbon | | | | | | | | | | polyolefin | | | crosslinking agent | | | | | polyol | | | catalyst | |
| | | a | b | c | d | e | f | g | h | i | j | k | l | m | n | o | p | q | r | s | t | u | v | w |
| Example | 1 | 10 | | | | | | | | | | 60 | 30 | | 3.0 | | | | | | 2.0 | | 1.0 | |
| | 2 | | 5 | | | | | | | | | 60 | 35 | | 3.0 | | | | | 1.0 | | | 0.2 | |
| | 3 | | 10 | | | | | | | | | 60 | 30 | | 3.0 | | | | | 1.0 | | | 0.2 | |
| | 4 | | 20 | | | | | | | | | 60 | 20 | | 3.0 | | | | | 1.0 | | | 0.2 | |
| | 5 | | | | 5 | | | | | | | 60 | 35 | | 3.0 | | | | | 2.0 | | | 0.2 | |
| | 6 | | | 10 | | | | | | | | 60 | 30 | | 0.5 | | | | | 2.0 | | | 0.2 | |
| | 7 | | | 20 | | | | | | | | 60 | 20 | | 10.0 | | | | | 3.0 | | | 0.2 | |
| | 8 | | 10 | | | | | | | | | 60 | 30 | | | 3.0 | | | | 2.0 | | | 0.2 | |
| | 9 | | 10 | | | | | | | | | 60 | 30 | | | | 3.0 | | | 2.0 | | | 0.2 | |
| | 10 | | 10 | | | | | | | | | 90 | | | 3.0 | | | | | 1.0 | | | | 0.6 |
| | 11 | | 10 | | | | | | | | | 70 | | 20 | 3.0 | | | | | | | 2.0 | 0.2 | |
| | 12 | | 5 | | | | | | | | | 75 | 20 | | | | | 3.0 | | 1.0 | | | 0.2 | |
| | 13 | | 5 | | | | | | | | | 75 | 20 | | | | | | 3.0 | 1.0 | | | 0.2 | |
| Comparative | 1 | | | | | 10 | | | | | | 60 | 30 | | 3.0 | | | | | 1.0 | | | 0.2 | |
| Example | 2 | | | | | | 10 | | | | | 60 | 30 | | 3.0 | | | | | 1.0 | | | 0.2 | |
| | 3 | | | | | | | 10 | | | | 60 | 30 | | 3.0 | | | | | 1.0 | | | 0.2 | |
| | 4 | | | | | | | | 10 | | | 60 | 30 | | 3.0 | | | | | 1.0 | | | 0.2 | |
| | 5 | | | | | | | | | 10 | | 60 | 30 | | 3.0 | | | | | 1.0 | | | 0.2 | |
| | 6 | | | | | | | | | 20 | | 60 | 20 | | 3.0 | | | | | 1.0 | | | 0.2 | |
| | 7 | | | | | | | | | | 10 | 60 | 30 | | 3.0 | | | | | 1.0 | | | 0.2 | |
| | 8 | | | | | | | | | | 20 | 60 | 20 | | 3.0 | | | | | 1.0 | | | 0.2 | |
| | 9 | | | | | | | | | | | 60 | 40 | | 3.0 | | | | | 1.0 | | | 0.2 | |
| | 10 | | | | | | | | | | | 100 | | | 3.0 | | | | | 1.0 | | | 0.2 | |

Each sample was evaluated as follows.

### [A] Low-Speed Peel Force

A prepared adhesive tape with a release material was preserved at 23° C. for 24 hr and pulled in a 180° direction at a rate of 0.3 m/min using a tensile tester, and a peel force measured in 23° C. atmosphere was taken as a low-speed peel force. The low-speed peel force in the present invention is preferably 0.10-0.30N/50 mm, and more preferably 0.10-0.25N/50 mm.

### [B] High-Speed Peel Force

A peel force measured under conditions similar to those of low-speed peel force except that the peel rate of the release material was changed to 3.0 m/min was taken as high-speed peel force. In the present invention, the high-speed peel force is preferably 0.4-1.0N/50 mm, more preferably 0.4-0.8N/50 mm.

[C] High-Speed Peel Force after Preservation Under Humidification

A prepared adhesive tape with a release material was preserved in a thermo-hygrostat at 40° C.×92% RH for 7 days, left standing at 23° C. atmosphere for 2 hr, and the release material was pulled by a tensile tester in a 180° direction at a rate of 3.0 m/min, and the peel force measured at 23° C. atmosphere was taken as the high-speed peel force after preservation under humidification. In the present invention, the high-speed peel force after preservation under humidification is preferably 0.5-1.5N/50 mm, more preferably 0.5-1.2N/50 mm.

### [D] Residual Adhesive Force

A prepared adhesive tape with a release material was preserved at 70° C. for 24 hr, and the test piece was cut in 20 mm width. According to JIS Z0237 “180° peel adhesion test”, the adhesive force was measured using a test plate (SUS304 steel plate abraded with No. 360 water-resistant abrasive paper) and used as a residual adhesive force. In the present invention, the residual adhesive force is preferably 4.8-7.0N/20 mm, more preferably 5.2-7.0N/20 mm.

dependence on peel rate ([B]/[A]) and dependence on peel rate after preservation under humidification ([C]/[A])

The dependence on the peel rate is obtained by dividing high-speed peel force by low-speed peel force. In the present invention, it is preferably not more than 5, more preferably not more than 4.

The dependence on the peel rate after preservation under humidification is obtained by dividing high-speed peel force after preservation under humidification by low-speed peel force. In the present invention, it is preferably not more than 7, more preferably not more than 6, most preferably not more than 5.

The results are shown in Table 7.

TABLE 7

| | | low-speed | high-speed | dependence | high-speed peel force | dependence on peel | |
|---|---|---|---|---|---|---|---|
| | | peel force | peel force | on peel | after preservation | rate after | residual adhesive |
| | | (N/50 mm) | (N/50 mm) | rate | under humidification | preservation under | force (N/20 mm) |
| | | [A] | [B] | [B]/[A] | (N/50 mm) [C] | humidification [C]/[A] | [D] |
| Example | 1 | 0.18 | 0.70 | 3.9 | 1.10 | 6.1 | 5.40 |
| | 2 | 0.18 | 0.70 | 3.9 | 1.06 | 5.9 | 5.33 |
| | 3 | 0.18 | 0.62 | 3.4 | 0.80 | 4.4 | 5.40 |
| | 4 | 0.17 | 0.54 | 3.2 | 0.66 | 3.9 | 5.32 |
| | 5 | 0.18 | 0.71 | 3.9 | 1.03 | 5.7 | 5.63 |
| | 6 | 0.20 | 0.63 | 3.2 | 0.81 | 4.1 | 5.40 |
| | 7 | 0.20 | 0.59 | 3.0 | 0.75 | 3.8 | 5.37 |
| | 8 | 0.18 | 0.62 | 3.4 | 0.84 | 4.7 | 5.45 |
| | 9 | 0.18 | 0.61 | 3.4 | 0.84 | 4.7 | 5.38 |
| | 10 | 0.18 | 0.63 | 3.5 | 0.82 | 4.6 | 5.30 |
| | 11 | 0.18 | 0.62 | 3.4 | 0.83 | 4.6 | 5.38 |
| | 12 | 0.18 | 0.69 | 3.8 | 1.02 | 5.7 | 5.33 |
| | 13 | 0.18 | 0.71 | 3.9 | 1.05 | 5.8 | 5.33 |
| Comparative | 1 | 0.18 | 0.90 | 5.0 | 1.53 | 8.5 | 5.43 |
| Example | 2 | 0.18 | 1.32 | 7.3 | 2.38 | 13.2 | 5.46 |
| | 3 | 0.19 | 1.58 | 8.3 | 2.86 | 15.1 | 5.53 |
| | 4 | 0.18 | 1.60 | 8.9 | 4.15 | 23.1 | 5.45 |
| | 5 | 0.19 | 1.21 | 6.4 | 2.27 | 11.9 | 5.60 |
| | 6 | 0.18 | 1.05 | 5.8 | 1.79 | 9.9 | 4.49 |
| | 7 | 0.18 | 1.04 | 5.8 | 1.75 | 9.7 | 5.43 |
| | 8 | 0.17 | 0.88 | 5.2 | 1.44 | 8.5 | 4.50 |
| | 9 | 0.18 | 1.60 | 8.9 | 4.40 | 24.4 | 5.40 |
| | 10 | 0.18 | 1.64 | 9.1 | 4.55 | 25.3 | 5.53 |

From Examples 1-13, release materials showing small dependence on the peel rate and small dependence on the peel rate after preservation under humidification, and superior in residual adhesive force were obtained.

On the other hand, it was confirmed that the release materials of Comparative Examples 1-10 have higher dependence on the peel rate than Examples 1-13. In addition, it was confirmed that the release materials of Comparative Examples 1-10 have high dependence on the peel rate after preservation under humidification.

Thus, a release material with reduced dependence on the peel rate and reduced dependence on the peel rate after preservation under humidification was not obtained from Comparative Examples.

Moreover, it was confirmed that the release materials of Comparative Examples 6, 8 have a low residual adhesive force.

<Adhesive Tape with Back Coating Layer>

### (Preparation of Adhesive Solution)

2-Ethylhexyl acrylate (190 parts), 2-hydroxyethyl acrylate (10 parts), azobisisobutyronitrile (0.4 parts) and ethyl acetate (372.2 parts) as a polymerization solvent were placed in a separable flask, and the mixture was stirred for 1 hr while introducing a nitrogen gas. In this way, oxygen was removed from the polymerization system, and the mixture was heated to 63° C. and reacted for 10 hr to give a solution containing an acrylic polymer having a solid content of 35%. The weight-average molecular weight of the acrylic polymer in this solution was one million.

Then, an isocyanate-based crosslinking agent (CORONATE L, manufactured by Nippon Polyurethane Industry Co., Ltd., 3 parts) and a crosslinking promoter (EMBILIZER OL-1, manufactured by Tokyo Fine Chemical CO., LTD., 0.02 parts) were added to 100 parts of the aforementioned acrylic polymer, and the mixture was diluted with toluene to give an adhesive solution having a concentration of 25%.

### (Preparation of Release Agent Solution)

TAFMER P-0280/LUCANT HC-2000/Epole/CORONATE L/dibutyltin dilaurate=90/10/2/0.5/1 (weight ratio of solid content) was dissolved in toluene to give a release agent solution having a concentration of 1.0%.

### (Preparation of Adhesive Tape)

The aforementioned release agent solution was applied to one surface of a 38 μm-thick polyester film by a kiss coater, and dried at 130° C. for 15 seconds to form a release agent layer having a dried thickness of 100 nm (back coating layer).

Then, the aforementioned adhesive was applied to the opposite surface of the obtained back coating layer by a reverse roll coater, and dried in 2 steps of 80° C.×15 seconds and then 130° C.×15 seconds to form an adhesive layer having a dried thickness of 25 μm. The tape was wound like a roll such that the adhesive layer was in the inner side to give an adhesive tape with a back coating layer.

The sequential steps from the formation of the release agent layer (back coating layer) to the formation of the adhesive layer and winding of the tape into a roll were performed at a line rate of 4 m/min.

The prepared adhesive tape could be rewound smoothly.

### INDUSTRIAL APPLICABILITY

The release agent of the present invention is superior in dependence of detachability on the rate and dependence of detachability on the rate after preservation under humidification, and therefore, can improve efficiency of peeling operation.

This application is based on patent application Nos. 2009-231844 and 2009-289741 filed in Japan, the contents of which are incorporated in full herein.

1. A polyolefin-based release agent comprising a liquid hydrocarbon having viscosity at 38° C. of 5-1500 Pa·s as measured according to JIS K7117-1.

2. The release agent according to claim 1, comprising a nonreactive polyolefin which is solid at 38° C.

3. The release agent according to claim 2, wherein the nonreactive polyolefin is an ethylene-based α-olefin copolymer.

4. The release agent according to claim 2, wherein the nonreactive polyolefin comprises not less than 90 wt % of a nonreactive polyolefin having tensile elasticity at 23° C. of not more than 10 MPa and tensile fracture stress at 23° C. of not more than 8 MPa.

5. The release agent according to claim 2, wherein the content of the liquid hydrocarbon is 3-30 parts by weight relative to the total 100 parts by weight of the liquid hydrocarbon and the nonreactive polyolefin.

6. The release agent according to claim 1, wherein the liquid hydrocarbon and the nonreactive polyolefin are contained in a total amount of not less than 80 wt % of the release agent.

7. The release agent according to claim 1, further comprising an isocyanate-based crosslinking agent.

8. The release agent according to claim 7, wherein the isocyanate-based crosslinking agent is an aromatic isocyanate having not less than 3 isocyanate groups in one molecule.

9. The release agent according to claim 8, wherein the aromatic isocyanate having not less than 3 isocyanate groups in one molecule is an adduct of an aromatic diisocyanate with a polyvalent alcohol.

10. The release agent according to claim 7, wherein the isocyanate-based crosslinking agent is an alicyclic isocyanate having not less than 3 isocyanate groups in one molecule.

11. The release agent according to claim 10, wherein the alicyclic isocyanate having not less than 3 isocyanate groups in one molecule is an adduct of an alicyclic diisocyanate with a polyvalent alcohol.

12. The release agent according to claim 1, further comprising polyolefin polyol.

13. The release agent according to claim 12, wherein the polyolefin polyol has a number-average molecular weight of 1500-50000.

14. The release agent according to claim 1, wherein the content of the isocyanate-based crosslinking agent is 0.5-20 parts by weight relative to the total 100 parts by weight of the liquid hydrocarbon and the nonreactive polyolefin.

15. A release material comprising a substrate and a release agent layer on at least one surface of the substrate, wherein the release agent layer comprises the release agent according to claim 1.

16. An adhesive tape comprising an adhesive layer and the release material according to claim 15 on at least one surface of the adhesive layer, wherein the adhesive layer is in contact with a release agent layer of the release material.

17. An adhesive tape comprising a substrate, an adhesive layer on one surface of the substrate, and a release agent layer comprising the release agent according to claim 1 on the other surface of the substrate.
